(19) United States
(12) Patent Application Publication
(10) Pub. No.: US 2008/0049557 A1
(43) Pub. Date: Feb. 28, 2008

(54) Common drive device for date/am/pm display

(76) Inventor: Tai-Her Yang, Si-Hu Town (TW)

Correspondence Address: BACON & THOMAS, 625 Slaters Lane - 4th Floor, Alexandria, VA, 22314-1176, US

(21) Appl. No.: 11/508,895

(22) Filed: Aug. 24, 2006

(51) Int. Cl. G04B 19/24

(52) U.S. Cl. 368/28

(57) ABSTRACT

A common drive device for date/am/pm display to change transmission ratio of driven mechanism with 24H as a stepping cycle found with the date display in window or indicator hand of the conventional timepiece into that with 12H as a stepping cycle; 00:00 at midnight and 12:00 at noon being usually set as the stepping timings for the 12H stepping cycle; or alternatively, 6:00 am and 6:00 pm, or any other pairs that are 12 hours separated from each other may be selected as required.

### BACKGROUND OF THE INVENTION

(a) Field of the Invention

The present invention is related to a common drive device for date/am/pm display, and more particularly, to one that changes the display date in the conventional timepiece with a digital display window or indicator hands stepping by day into two steps by day so to distinguish the display between the first and second 12-hour periods while displaying the date; for example, 00:00 at midnight and 12:00 at noon are selected as the stepping timings; furthermore, am or pm is displayed together with the display of date by distinguishing the date display from the size of the typeface, background color of the typeface, color of the typeface, geometric pattern of the typeface, the geometric pattern of the background of the typeface, or having the indicator hand of date relatively resided at different scales during the same day.

(b) Description of the Prior Art

Whereas the date display on a conventional timepiece operates by day, that is, stepping day by day as illustrated in FIGS. 1 and 2 of the accompanying drawings, display devices are separately provided for the driven and display of the first 12 hours and the second 12 hours in a comparatively more tedious and complicate construction.

### SUMMARY OF THE INVENTION

The primary purpose of the present invention is to provide a common drive device for date/am/pm display to change transmission ratio of driven mechanism with 24H as a stepping cycle found with the date display in window or indicator hand of the conventional timepiece into that with 12H as a stepping cycle, 00:00 at midnight and 12:00 at noon are usually set as the stepping timings for the 12H stepping cycle; or alternatively, 6:00 am and 6:00 pm, or any other pairs that are 12 hours separated from each other may be selected as required.

### BRIEF DESCRIPTION OF THE DRAWINGS

FIG. 1 is a schematic view showing a date digital display window on a conventional timepiece.

FIG. 2 is a schematic view showing a date indicator hand on a conventional timepiece.

FIG. 3 is a schematic view showing the use of different sizes of typeface to distinguish date display with indicator hand between two different 12H periods of the present invention.

FIG. 4 is a schematic view showing the use of different sizes of typeface to distinguish date display in a window between two different 12H periods of the present invention.

FIG. 5 is a schematic view showing the use of different colors of typeface to distinguish date display with indicator hand between two different 12H periods of the present invention.

FIG. 6 is a schematic view showing the use of different colors of typeface to distinguish date display in a window hand between two different 12H periods of the present invention.

FIG. 7 is a schematic view showing the use of different background colors of typeface to distinguish date display with indicator hand between two different 12H periods of the present invention.

FIG. 8 is a schematic view showing the use of different background colors of typeface to distinguish date display in a window hand between two different 12H periods of the present invention.

FIG. 9 is a schematic view showing the use of different geometric patterns of typeface to distinguish date display with indicator hand between two different 12H periods of the present invention.

FIG. 10 is a schematic view showing the use of different geometric patterns of typeface to distinguish date display in a window hand between two different 12H periods of the present invention.

FIG. 11 is a schematic view showing the use of different background geometric patterns of typeface to distinguish date display with indicator hand between two different 12H periods of the present invention.

FIG. 12 is a schematic view showing the use of different background geometric patterns of typeface to distinguish date display in a window hand between two different 12H periods of the present invention.

FIG. 13 is a schematic view showing that the indicator hand resides at different scales within that for the same day to distinguish date display between two different 12H periods of the present invention.

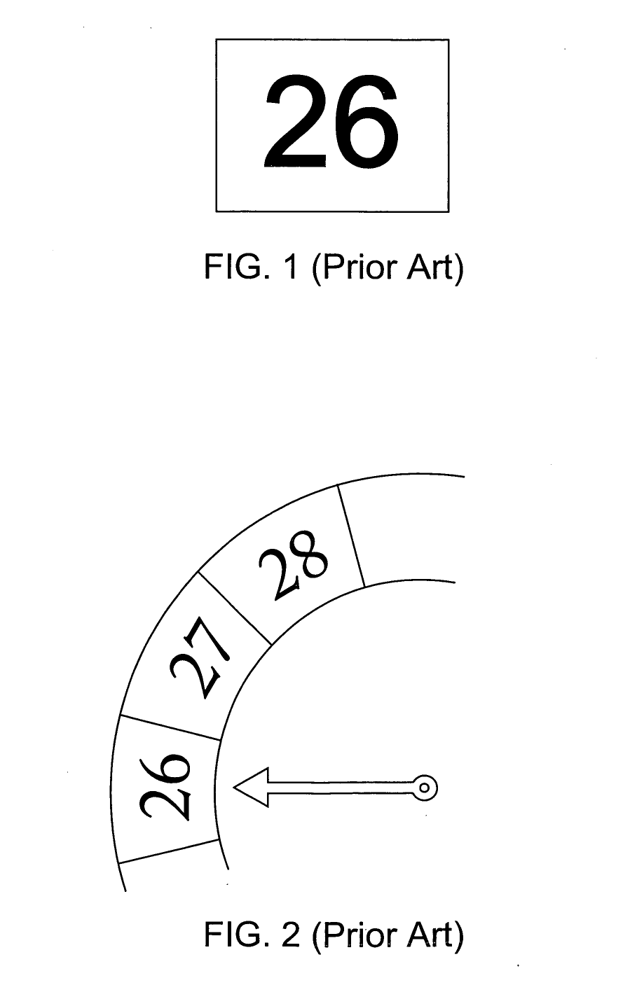

### DETAILED DESCRIPTION OF THE PREFERRED EMBODIMENTS

The present invention relates to a common drive device for date/am/pm display in a timepiece with mechanical or quartz movement mechanically or electrically powered, or one displaying the time by receiving radio signals; the present invention preserves power source, timing mechanism, time display device other than that for am/pm, additional function and casing members of the prior art with an innovative mechanism provided to drive and display in relation to the date display function; the innovative mechanism is characterized in that:

The conventional stepping cycle by day with 0:00 at midnight (expressed as 24 hours, zero hour, or 12:00 AM) is changed to having 12H as a stepping cycle with 0:00 at midnight (24 hours, zero hour or 12:00 AM) and 12:00 at noon (12:00 PM); or 6:00 AM and 6:00 PM; or any other pair of time so far as they are a lapse of 12 hours as date stepping timings for 12H periods;

The transmission ratio of a drive mechanism of the conventional date display with its stepping cycle by day is changed to that with a stepping cycle by half a day (12 hours); and

The display remains displaying the same date after two stepping cycles while providing different fashions of display between two 12H periods of time.

FIGS. 3 through 13 show multiple preferred embodiment of the present invention. To make the innovative part to stand out, timing mechanism, time display other than date/am/pm, or any additional function and casing are omitted:

The common drive device for display of date/am/pm of the present invention allows display fashion covering two 12H periods of time to be contained under the function of display of same date as respectively disclosed in the following preferred embodiments:

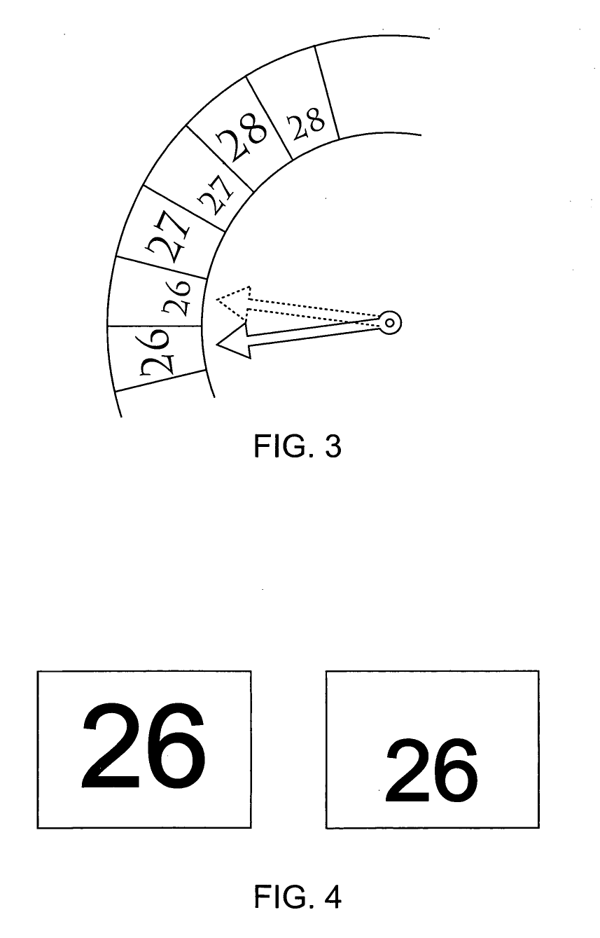

(1) Both 12H periods of time are identified by size of the typeface for date display to distinguish the display respectively for two different 12H periods of time in different sizes of typeface for display as illustrated in FIG. 3 when the date is displayed by an indicator hand or in FIG. 4 when the date is displayed by digits in a window; or

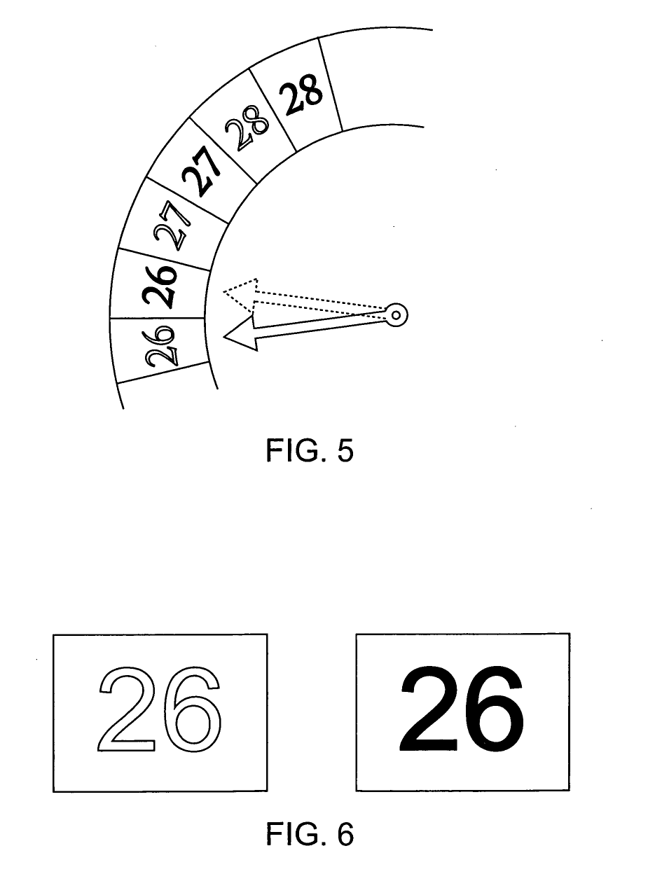

(2) Both 12H periods of time are identified by color of the typeface for date display to distinguish the display respectively for two different 12H periods of time in different colors of typeface for display as illustrated in FIG. 5 when the date is displayed by an indicator hand or in FIG. 6 when the date is displayed by digits in a window; or

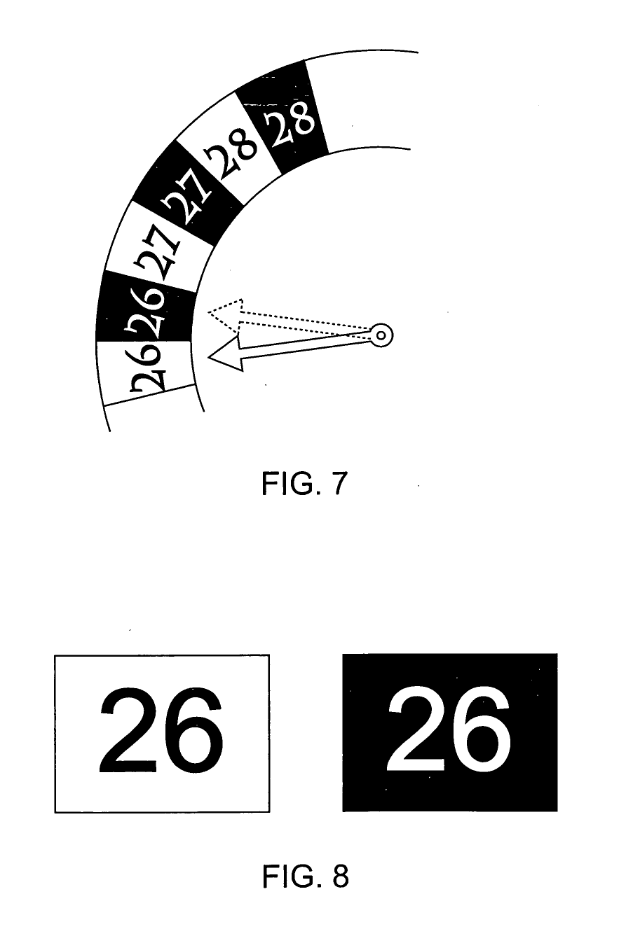

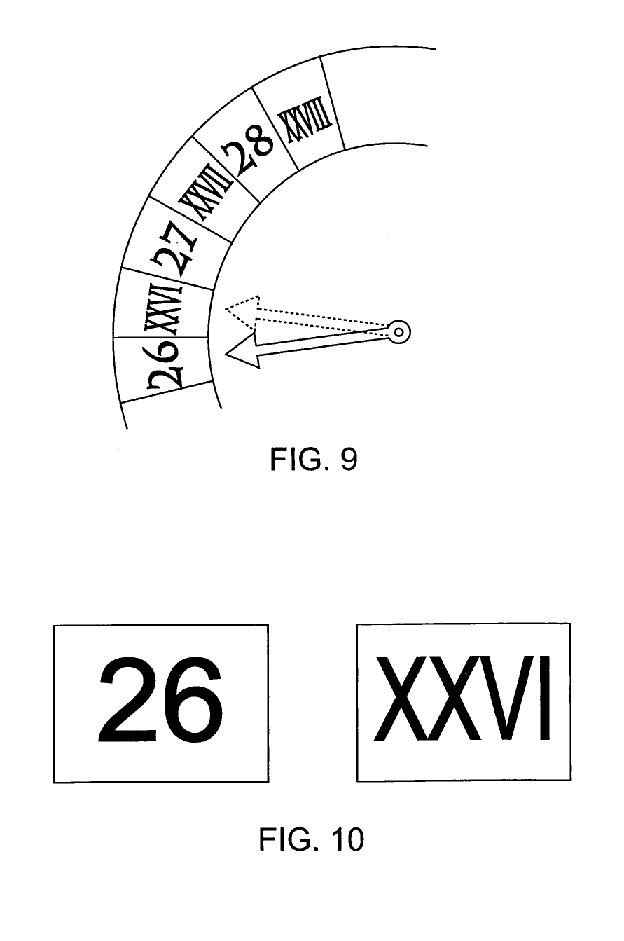

(3) Both 12H periods of time are identified by background color of the typeface for date display to distinguish the display respectively for two different 12H periods of time in different background colors of typeface for display as illustrated in FIG. 7 when the date is displayed by an indicator hand or in FIG. 8 when the date is displayed by digits in a window; or

(4) Both 12H periods of time are identified by geometric pattern of the typeface for date display to distinguish the display respectively for two different 12H periods of time in different geometric patterns of typeface for display as illustrated in FIG. 9 when the date is displayed by an indicator hand or in FIG. 10 when the date is displayed by digits in a window; or

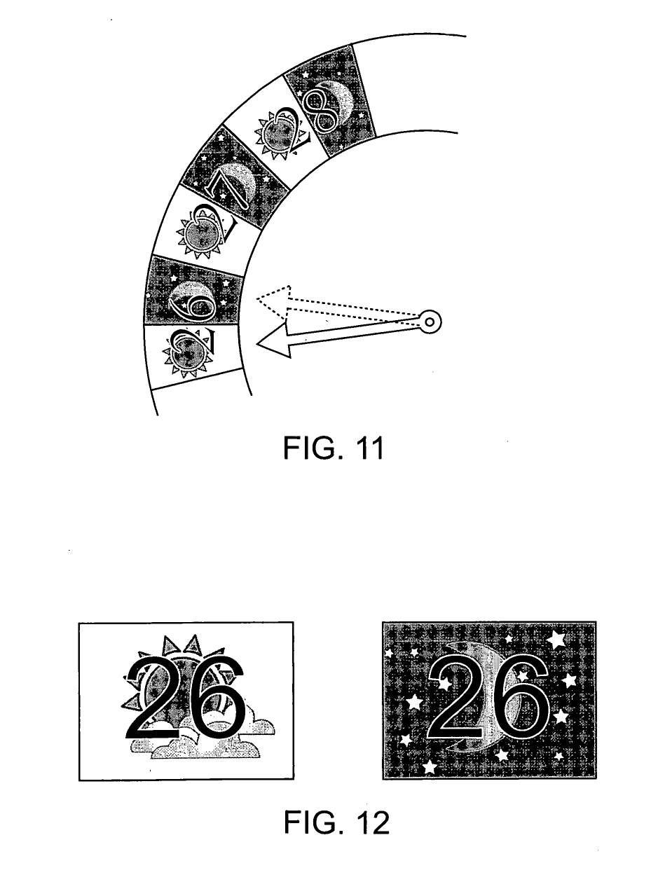

(5) Both 12H periods of time are identified by geometric pattern of background of the typeface for date display to distinguish the display respectively for two different 12H periods of time in different geometric patterns the background of typeface for display as illustrated in FIG. 11 when the date is displayed by an indicator hand or in FIG. 12 when the date is displayed by digits in a window; or

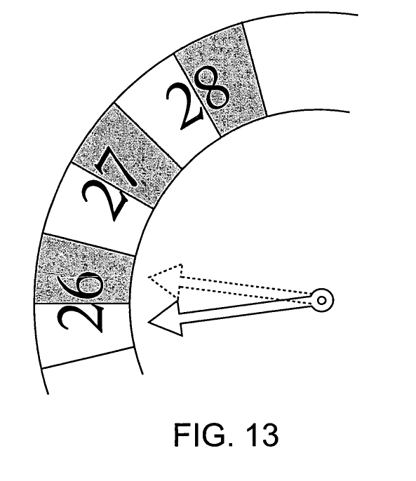

(6) Within the scope of the scales for the same date when the indicator hand is used to display date, the indicator hand is made to reside on different positions of scale as illustrated in FIG. 13 to distinguish the display fashions between both 12H periods of time.

All those preferred embodiments given above are for reference in the description of the present invention. The practical application of the present invention include any other visual display means of the prior art that is sufficient to distinguish two different 12H periods of time based on the principle of display of the same date.

The common drive device for date/am/pm display of the present invention includes:

display window: relates to a window drive and display device comprised of digital wheel or digital dial for stepping display, or other structure that is capable of providing visual identification of the display fashion respective for the first 12H and the second 12H periods of time while displaying the date; wherein,
(1) The same date displays during both of the first and the second 12H periods of time and the display fashions respectively for both 12H periods of time are distinguished from the size of typeface for date display, or color of typeface for date display, or the geometric pattern of the typeface for display;
(2) The same date displays during both of the first and the second 12H periods of time and the display fashions respectively for both 12H periods of time are distinguished from the background color of typeface for date display, or geometric pattern of the background of the typeface for display;
(3) The same date displays during both of the first and the second 12H periods of time and the display fashions respectively for both 12H periods of time are distinguished from the size of typeface for date display, or color of typeface for date display, or the geometric pattern of the typeface for display and the background color of the typeface for date display or the geometric pattern of the background of typeface for display; or any combination of those fashions of display described above in providing visual identification of the first 12H or the second 12H period of time;

Indicator hand display device: stepping to advance by an indicator hand is applied in date display; and in the status of displaying the same date, fashions for display of the first 12H and the second 12H periods of time includes:
(1) With the range of display scales for the same date, scales for both of the first and the second 12H periods of time are provided and a resident mechanism is disposed to the indicator hand corresponding to the scales that provides stepping twice a day for simultaneously displaying the date and the first 12H period of time or the second 12H period of time; accordingly, the same date displays during the first and the second 12H periods of time covered by that date;
(2) Color blocks, geometric lines, digits, and scope of scales covered by a same date are defined as the scope for display of that same date and cover various indicating positions between the first and the second 12H periods of time attributable to that same date; accordingly, the same date displays during the first and the second 12H periods of time covered by that date; and
(3) The scale corresponding to the indicator hand indicates for the separate 12H period of time within the first and the second 12H periods of time during the same date indicates different colors, geometric lines, character forms, colors of pattern or size of pattern while the same date displays during the first and the second 12H periods of time covered by that date.

To sum up, a common drive device for date/am/pm display of the present invention is advanced and innovative by allowing the simultaneous display of the date and either of the first or the second 12H period of time within the same structure to facilitate telling the time and date by omitting the am/pm display mechanism additional to the date display as found with the conventional timepiece to achieve relatively simple construction and the complication of the face panel.

1. A common drive device for date/am/pm display in a timepiece with mechanical or quartz movement mechanically or electrically powered, or one displaying the time by receiving radio signals; power source, timing mechanism, time display device other than that for am/pm, additional function and casing members of the prior art being reserved with an innovative mechanism provided to drive and display in relation to the date display function with the innovative mechanism being characterized in that:
the conventional stepping cycle by day with 0:00 at midnight (expressed as 24 hours, zero hour, or 12:00 AM) is changed to having 12H as a stepping cycle with 0:00 at midnight (24 hours, zero hour or 12:00 AM) and 12:00 at noon (12:00 PM); or 6:00 AM and 6:00 PM; or any other pair of time so far as they is a lapse of 12 hours as date stepping timings for 12H periods;
the transmission ratio of a drive mechanism of the conventional date display with its stepping cycle by day is changed to that with a stepping cycle by half a day (12 hours); and
the display remains displaying the same date after two stepping cycles while providing different fashions of display between two 12H periods of time.

2. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the size of the typeface when the date is displayed at the same time by an indicator hand.

3. The common drive device for date/am/pm display as claimed in claim 1, wherein the display fashion for both 12H periods of time covered for expression in the display of the same date is covered by the function of displaying the same date and the display fashions respectively for both 12H periods of time are distinguished by the size of the typeface when the date is displayed at the same time by digits in a window.

4. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the color of the typeface when the date is displayed at the same time by an indicator hand.

5. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the color of the typeface when the date is displayed at the same time by digits in a window.

6. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the background color of the typeface when the date is displayed at the same time by an indicator hand.

7. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the background color of the digits when the date is displayed at the same time by digits in a window.

8. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the geometric pattern of the typeface when the date is displayed at the same time by an indicator hand.

9. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the geometric pattern of the digits when the date is displayed at the same time by digits in a window.

10. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the geometric pattern of the background of the typeface when the date is displayed at the same time by an indicator hand.

11. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by the geometric pattern of the background of digits when the date is displayed at the same time by digits in a window.

12. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by having the indicator hand to reside at different positions of the scale within the range of the scales of the same date.

13. The common drive device for date/am/pm display as claimed in claim 1, wherein the display fashions respectively for both 12H periods of time covered for expression in the display of the same date are covered by the function of displaying the same date and the display fashions respectively for both 12H periods of time are distinguished by visual display of the prior art based on the similar principle of displaying the same date.

14. The common drive device for date/am/pm display as claimed in claim 1, including a display window relates to a window drive and display device comprised of digital wheel or digital dial for stepping display, or other structure that is capable of providing visual identification of the display fashion respective for the first 12H and the second 12H periods of time while displaying the date, includes, the same date displays during both of the first and the second 12H periods of time and the display fashions respectively for both 12H periods of time are distinguished from the size of typeface for date display, or color of typeface for date display, or the geometric pattern of the typeface for display.

15. The common drive device for date/am/pm display as claimed in claim 1, including a display window relates to a window drive and display device comprised of digital wheel or digital dial for stepping display, or other structure that is capable of providing visual identification of the display fashion respective for the first 12H and the second 12H periods of time while displaying the date, includes, the same date displays during both of the first and the second 12H periods of time and the display fashions respectively for both 12H periods of time are distinguished from the background color of typeface for date display, or geometric pattern of the background of the typeface for display.

16. The common drive device for date/am/pm display as claimed in claim 1, including a display window relates to a window drive and display device comprised of digital wheel or digital dial for stepping display, or other structure that is capable of providing visual identification of the display fashion respective for the first 12H and the second 12H periods of time while displaying the date, includes, the same date displays during both of the first and the second 12H periods of time and the display fashions respectively for both 12H periods of time are distinguished from the size of typeface for date display, or color of typeface for date display, or the geometric pattern of the typeface for display and the background color of the typeface for date display or the geometric pattern of the background of typeface for display; or any combination of those fashions of display described above in providing visual identification of the first 12H or the second 12H period of time.

17. The common drive device for date/am/pm display as claimed in claim 1, including an indicator hand display device stepping to advance by an indicator hand is applied in date display; and in the status of displaying the same date, fashions for display of the first 12H and the second 12H periods of time includes: with the range of display scales for the same date, scales for both of the first and the second 12H periods of time are provided and a resident mechanism is disposed to the indicator hand corresponding to the scales that provides stepping twice a day for simultaneously displaying the date and the first 12H period of time or the second 12H period of time; accordingly, the same date displays during the first and the second 12H periods of time covered by that date.

18. The common drive device for date/am/pm display as claimed in claim 1, including an indicator hand display device stepping to advance by an indicator hand is applied in date display; and in the status of displaying the same date, fashions for display of the first 12H and the second 12H periods of time includes: color blocks, geometric lines, digits, and scope of scales covered by a same date are defined as the scope for display of that same date and cover various indicating positions between the first and the second 12H periods of time attributable to that same date; accordingly, the same date displays during the first and the second 12H periods of time covered by that date.

19. The common drive device for date/am/pm display as claimed in claim 1, including an indicator hand display device stepping to advance by an indicator hand is applied in date display; and in the status of displaying the same date, fashions for display of the first 12H and the second 12H periods of time includes: the scale corresponding to the indicator hand indicates for the separate 12H period of time within the first and the second 12H periods of time during the same date indicates different colors, geometric lines, character forms, colors of pattern or size of pattern while the same date displays during the first and the second 12H periods of time covered by that date.
